(19) United States
(12) Patent Application Publication
(10) Pub. No.: US 2014/0161941 A1
(43) Pub. Date: Jun. 12, 2014

(54) Lights and sound enhancements for use with edible constructions

(71) Applicant: Brand Castle LLC, Cleveland, OH (US)

(72) Inventor: James E. Zeilinger, Cleveland, OH (US)

(73) Assignee: BRAND CASTLE LLC, CLEVELAND, OH (US)

(21) Appl. No.: 13/998,783

(22) Filed: Dec. 4, 2013

Related U.S. Application Data
(60) Provisional application No. 61/797,490, filed on Dec. 8, 2012.

(51) Int. Cl. H01R 33/88; H01F 38/14; A21D 13/00

(52) U.S. Cl. CPC H01R 33/88; A21D 13/009; H01F 38/14
USPC 426/132; 439/668; 307/104

(57) ABSTRACT

A kit includes a plurality of food ingredients to form at least a part of an edible construction, and a plurality of low voltage electrical components able to be electrically coupled and assembled with the edible construction to visually enhance the edible construction. Among the electrical components may be a base that provides a substantially flat support surface on which the edible construction may be positioned and an overlay sheet to overlie the support surface and visually present indicia indicating at least one location at which a portion of the edible construction or electrical components such as lighting or audio components may be positioned.

### REFERENCE TO PROVISIONAL APPLICATION

This Utility Application claims the benefit of the filing date of Provisional Application Ser. No. 61/797,490 filed Dec. 8, 2012 entitled LIGHTS AND SOUND ENHANCEMENTS FOR USE WITH EDIBLE CONSTRUCTIONS (Atty's Docket 6-740), the disclosure of which is incorporated herein by reference.

### BACKGROUND

The present invention relates to relatively inexpensive, low voltage electrical items preferably packaged or arranged in kits for bringing audio and/or visual enhancements to constructions formed or built with edible materials. More particularly, the present invention relates to relatively inexpensive, low voltage electrical items preferably arranged in kit form, that may be sold on grocery store shelves and the like, containing lights or lighting components, and/or music and other types of sound components that are well suited for safe use with edible constructions.

It has long been known to build a wide variety of seasonal and non-seasonal constructions such as houses, trees, sleighs, and whole scenes populated by objects of a wide variety of descriptions, formed from edible products such as gingerbread, sugar cookies, crispy rice treats and other food items that may, themselves, be utilized to form elements of a scene, or as components in the building of visually attractive and entertaining edible constructions.

Holidays such as Christmas, New Years Day, Independence Day, Halloween and various other religious, patriotic and ethnic holidays have provided seasonal stimuli for creating edible constructions. Likewise, birthdays, anniversaries and similar other occasions for celebration, as well as the enjoyment that derives from involving one's children in the making, baking and assembly of edible constructions, all have provided catalysts for the creation and enjoyment of edible constructions, not the least of which are the traditional and often elaborate cakes that commonly are provided for birthdays and weddings.

Although food construction kits are being sold for use in building various types of edible constructions, there are no kits being sold that specifically provide relatively inexpensive, low voltage, electrical components intended to safely enhance edible constructions by providing decorative lights, interior and exterior illumination, and/or audio effects, including sounds and/or music that augment and enrich a season or occasion being celebrated.

Further, there are no kits being sold that specifically provide for organizing the placement or provision of electric power to such lighting and audio components. No such kits exist that provide a platform to assist in the positioning of portions of edible constructions, or in organizing the routing of, electrical conductors between and among such electrical components.

### SUMMARY

The present invention addresses such needs and deficiencies as are explained above by providing, preferably in kit form, a variety of types of relatively inexpensive, low voltage sets of electrical components that are designed to be easily interconnected by adults or supervised children, to safely provide decorative lighting, interior or exterior illumination, and/or sound enhancements, to, and for use with, a wide variety of edible constructions.

In one form of preferred practice of the invention, low voltage electrical components are provided in kit form, with components of the kits being safely electrically interconnectable in a variety of ways—kits that can be used to safely provide illumination or decorative lighting as well as appropriate music and/or sounds for augmenting edible constructions and for enriching the seasons or occasions that particular edible constructions are provided to celebrate.

In one preferred practice of the invention, kits are provided that contain a variety of relatively inexpensive, low voltage, electrical components which are well suited to be easily and safely electrically interconnected and utilized to provide electrical lighting, decorative lights, and/or sound effects to accompany and add entertainment value, interest and enjoyment to such edible constructions as buildings, furniture, yard decorations, animals, people, cars, trains, planes, roadways, airports, and whole city and country scenes—including seasonal scenes and structures such as may be provided at Halloween and Christmas, or that may be built in conjunction with other occasions of celebration.

In one form of preferred practice, enhancement kits are provided that include a variety of low voltage, safely and easily interconnectable electrical components that specifically include strings, groups or sets of inexpensive light-emitting diode (LED) types of lights for adding to the viewing enjoyment of edible constructions.

In another form of preferred practice, enhancement kits are provided that include a variety of low voltage, safely and easily interconnectable electrical components that specifically include relatively inexpensive groups or sets of audio components designed to provide music or other sounds well-suited for augmenting an edible construction with which elements of an enhancement kit are used, or for enriching a season or occasion that a particular edible construction celebrates.

In yet another form of preferred practice, enhancement kits are provided that include a variety of low voltage, safely and easily interconnectable electrical components accompanied by a base component to physically support the edible constructions into which the electrical components may integrated. The base component preferably provides distribution of electric power and/or integrates control features enabling convenient centralized control over the operation of the electrical components.

In one form of preferred practice, visual and/or audio enhancement kits for use with edible constructions are provided in sealed packets or packages that are well suited for display on shelves in substantially any sort of commercial products sales establishment, including but not limited to craft and hobby stores, and the like. These enhancement kits preferably include at least some relatively low cost light-emitting diode (LED) type lights.

In another form of preferred practice, lighting and/or audio enhancement kits are provided in boxes that contain sets of relatively inexpensive, low voltage components that are easily and safely electrically interconnected, with the boxes being of substantially the same size and having an appearance resembling that of the boxed kits that are offered for sale containing ingredients for use in making, baking and forming edible constructions. As such, the boxed enhancement kits are well suited to be sold in grocery and food specialty stores, and on shelves positioned side-by-side with boxed kits for making, baking and building various types of edible constructions.

In yet another preferred practice of the invention, light enhancement kits, sound enhancement kits, and combination light and sound enhancement kits are provided in sealed packets or packages that are offered for sale within boxes that also contain sealed packets or packages of food products that can be used to form the elements from which edible constructions of a wide variety of types can be built or otherwise provided.

In one form of preferred practice, lighting and/or audio enhancement kits for use with edible constructions are provided that include a base component and accompanying overlay sheet to cooperate with an assortment of apertures of the base component to provide guidance and physical support for the placement of portions of an edible construction and electrical components integrated therewith. The base component preferably provides distribution of electric power to the electrical components along with such physical support.

In one form of preferred practice, lighting and/or audio enhancement kits for use with edible constructions are provided that include a base component employing, optically conductive materials to distribute light to lighting components to be integrated with edible constructions. The base component is preferably accompanied by an overlay sheet to cooperate with an assortment of apertures of the base component to provide guidance and physical support for the placement of portions of an edible construction and lighting components therewith.

These and other modifications, enhancements, developments and improvements relating to safely interconnectable electrical components preferably sold in kit form for use in enhancing, augmenting and enriching one's experience associated with edible constructions are intended to be protected by claims of a utility patent application filed within a year of the filing date of this provisional application.

### BRIEF DESCRIPTION OF THE DRAWINGS

A fuller understanding of what is disclosed in the present application may be had by referring to the description and claims that follow, taken in conjunction with the accompanying drawings, wherein:

FIG. 1 is a perspective view of an embodiment of a kit that contains both food elements for making, baking or otherwise forming edible constructions or components, thereof, and low voltage electrical components that may be interconnected in a variety of creative ways to enhance edible constructions;

FIG. 2 is a perspective view showing a set of relatively inexpensive electrical components that may be included in one of the bag-like packets of FIG. 1;

FIG. 3 is a perspective view on an enlarged scale showing one of the electrical components of FIG. 2 and a portion of the other, and showing an embodiment of coupling of the two electrical components;

FIG. 4 is a sectional view of the embodiment of coupling of the two electrical components of FIG. 3;

FIG. 5 is a different perspective view of the portion of the electrical component of FIG. 3;

FIG. 6 is a perspective view, similar to FIG. 2, of an alternate set of relatively inexpensive electrical components that may be included in one of the bag-like packets of FIG. 1;

FIG. 7 is a perspective view of another alternate set of relatively inexpensive electrical components, some similar to those of FIG. 6, that may be included in one of the bag-like packets of FIG. 1;

FIG. 8, is a schematic view of electrical circuitry of a subset of the electrical components of either of FIGS. 2 or 6;

FIG. 9 is a perspective view, similar to FIGS. 2 and 6, of still another alternate set of relatively inexpensive electrical components that may be included in one of the bag-like packets of FIG. 1;

FIG. 10, is a schematic view of electrical circuitry of a subset of the electrical components of FIG. 9;

FIG. 11 is a perspective view of a edible construction employing electrical components of any of the embodiments of FIGS. 2, 6 or 9 in its assembly;

FIG. 12 is a perspective view on an enlarged scale showing one of the electrical components of FIG. 11; and

FIG. 13 is a block diagram of an example processing architecture that may be employed by any of the embodiments of FIGS. 2, 6 or 9.

### DETAILED DESCRIPTION

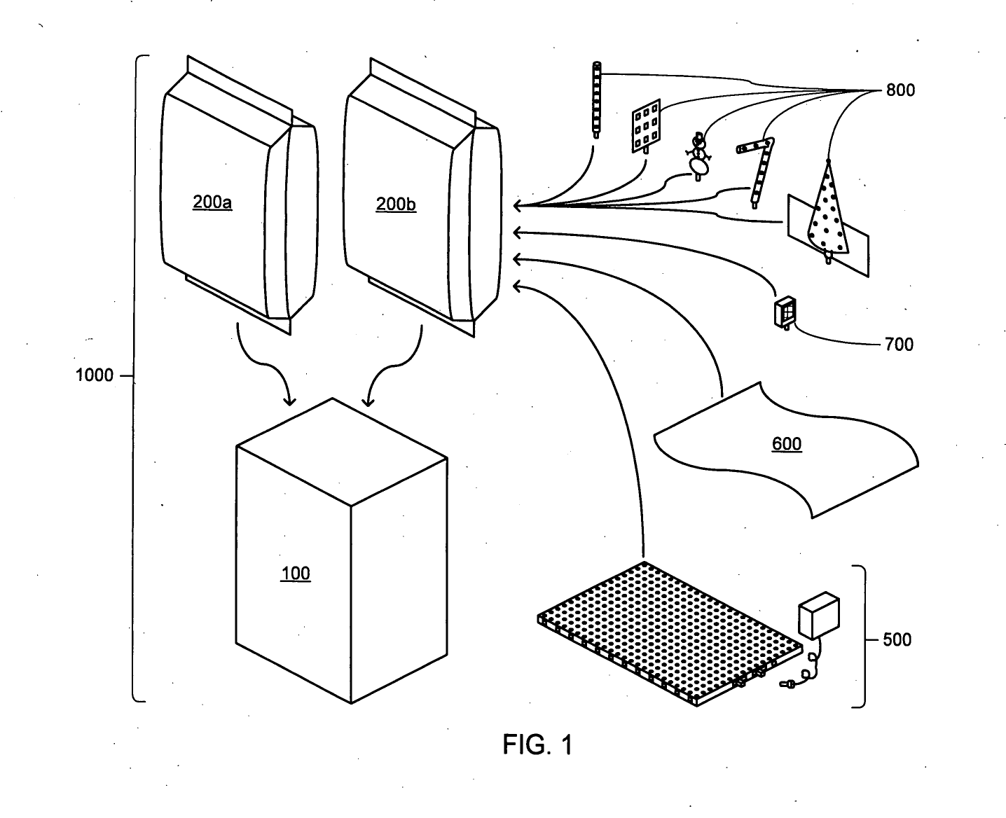

Referring to FIG. 1, a kit for creating edible constructions augmented with lighting and/or sounds is indicated by the numeral 1000. Food ingredients and/or electrical components of the kit 1000 may be contained for transport and/or storage within a pair of packets 200a and 200b protectively enclosed within a box 100.

The box 100 is of the type that can be used to contain and offer for sale such products as may be sold on shelves of commercial establishments including, but not limited to grocery stores, food specialty stores and the like. The box 100 may protectively enclose one or more sealed packets or packages that contain food kit ingredients for use in creating, baking, cooking or otherwise providing edible constructions or components thereof, together with one or more sealed packets or packages that contain electrical components for use in augmenting an edible construction or for enriching the visual or audio experience provided by an edible construction.

For example, one or both of the packets 200a-b may be inserted into, or protectively enclosed within, and/or sold while inside a container or package such as the box 100. Although the packets 200a-b are depicted as being of substantially identical size and shape, the packets 200a-b may differ in size and shape, depending on the size and shape of such components or ingredients as are housed in each of the packets 200a-b.

The packet 200a may, for example, enclose mix-together ingredients (not shown) that can be baked in molds or otherwise cooked or prepared to provide food elements or components from which various types of edible constructions may be formed, assembled or built. The edible constructions may be formed with a wide variety of food ingredients enclosed within the packet 200a, including but not limited to food ingredients that are used to form such items as gingerbread, sugar cookies, crispy rice treats and the like.

Alternatively or additionally, the packet 200a may, for example, house one or more pre-baked or otherwise pre-cooked portions of an edible construction (e.g., a portion of a wall or roof of a gingerbread house) to enable the assembly of the edible construction without mixing food ingredients, baking, cooking, etc. Such portions of an edible construction may be individually wrapped (e.g., each within its own packet, such as the packet 200a) and/or surrounded by protective material (e.g., each within a miniature cardboard box or surrounded by bubble wrap).

Alternatively or additionally, the packet 200b may, for example, protectively enclose relatively inexpensive, low voltage electrical components that can be easily and safely interconnected in a variety of ways to provide decorative lighting, or interior or exterior illumination, and/or music or sounds that are appropriate for augmenting or enriching the visual and/or audio experience provided by a particular edible construction.

Referring still to FIG. 1, a set of relatively inexpensive., low voltage electrical components such as may be included in the packet 200b is indicated generally by the numerals 500, 700 and/or 800. More specifically, included among electrical components of the kit 1000 may be a base 500 atop which edible constructions may be assembled and/or to which various ones of the other electrical components 700 and/or 800 may be electrically coupled. Alternatively or additionally, included among the electrical components of the kit 1000 may be an audio component 700 that may be coupled to one or more of the other electrical components 500 and/or 800 to provide audible enhancements to edible constructions that may be assembled atop the base 500. Alternatively or additionally, included among the electrical components of the kit 1000 may be one or more lighting components 800 that may be coupled to one or more of the electrical, components 500 and/or 700, and/or may be coupled to one or more other lighting components 800 to provide visual enhancements to edible constructions that may be assembled atop the base 500.

Further, an overlay sheet that may be included in the packet 200b is indicated generally by the numeral 200. More specifically, included in the kit 1000 may be one or more overlay sheets 600 on which may be visually presented (e.g., printed) various indicia of locations at which to position one or more portions of an edible construction and/or one or more of the electrical components 700 and/or 800.

Thus, for example, various ingredients of the kit 1000 may be baked, cooked or otherwise prepared to provide portions of an edible construction (e.g., a gingerbread house), or such portions of an edible construction may be provided in the kit 1000 to enable assembly of the edible construction without such baking, cooking, etc. The overlay sheet 600 may be placed atop the base 500 to enable various indicia visually presented on an up-facing surface thereof to guide the positioning of those portions of the edible construction to be physically supported by the base 500. Alternatively or additionally, various indicia visually presented on the up-facing surface of the overlay sheet 600 may, guide the positioning of one or more electrical components 700 and/or 800, including the locations at which to poke electrical connectors of the one or more electrical components 700 and/or 800 through the overlay sheet 600 to at least obtain electrical power from the base 500. In this way, a child and/or adult may be guided through creating and assembling an edible construction, as well as well as enhancing it with the addition of various lighting and/or sound features.

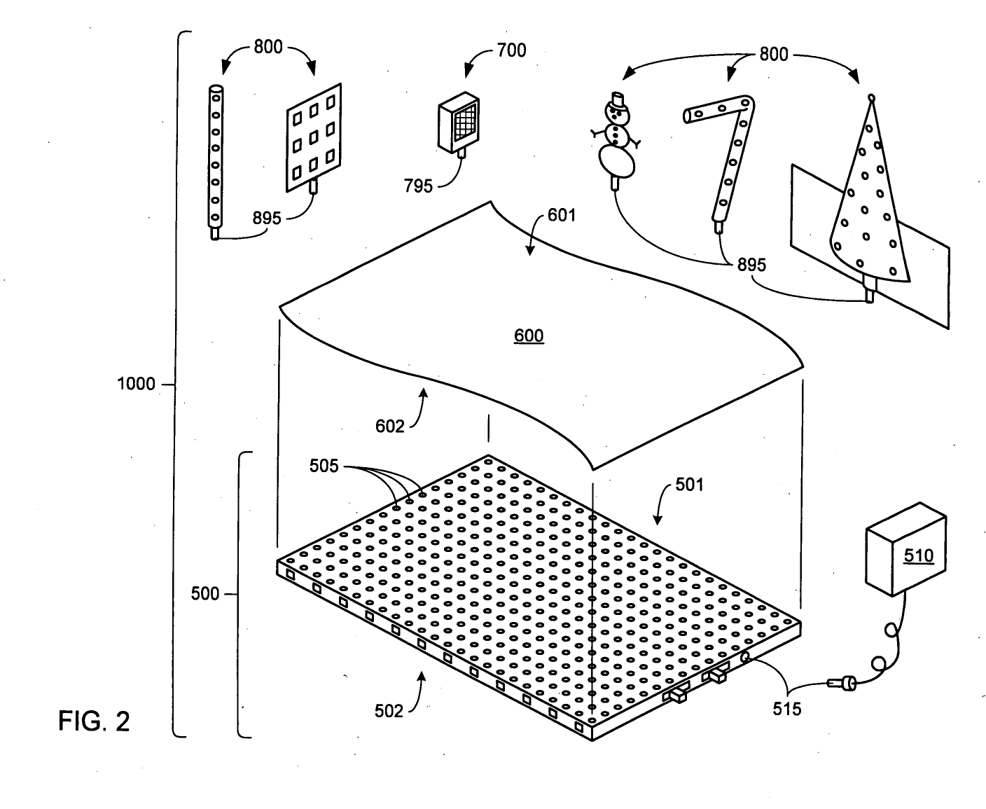

Referring to FIG. 2, embodiments of the electrical components 500, 700 and 800, along with an embodiment of an overlay sheet 600, are presented in perspective on an enlarged scale to facilitate their depiction and discussion in greater detail.

As depicted, the base 500 may be of a substantially flat rectangular shape having a support surface 501 atop which edible constructions and/or one or more electrical components 700 and/or 800 may be physically supported, and an underside 502 opposite the support surface 501. However, despite the depiction of the base 500 having such a rectangular shape, other embodiments are possible in which the base 500 may have any of a wide variety of curved and/or polygonal shapes.

The base 500 may have a thickness in the range of a quarter inch to a half inch to enable various electrical conductors, connectors, controls, lighting elements, etc. to be incorporated therein. The support surface 501 may be penetrated at numerous locations by a plurality of apertures 505 formed therethrough. The aperture 505 may form a grid giving the based 500 an appearance resembling a “peg board” or “bread board” by which ones of the electrical components 700 and/or 800 may be physically supported.

As previously discussed, the base 500 may distribute electric power to others of the electrical components 700 and/or 800. The base 500 may receive that electric power from a power source 510 external to the base and coupled thereto 500 via mating connectors 515 of the base 500 and of the power source 510. The power source 510 may include one electric power storage components (e.g., batteries) and/or may be capable of being coupled to a source of electric power (e.g., AC mains). Alternatively or additionally, the base 500 may internally incorporate a power source (e.g., one or more batteries).

As depicted, the audio component 700 may be of a substantially box-like shape and incorporate an acoustic driver operable via the provision of electric power and/or signaling to generate a sound. However, despite the depiction of the audio component 700 having such a box-like shape, other embodiments are possible in which the audio component 700 may have any of a wide variety of shapes, including and not limited to shapes resembling animals, plants, people, such as objects as may be found in countryside scenery, etc. The sound generated may be any of a wide variety of sounds, including and not limited to animal sounds, outdoor environmental sounds, weather sounds, voice, music, sounds commonly associated with various holidays, etc.

The audio component 700 incorporates a connector 795 by which the audio component 700 may be coupled to the base 500 to receive electric power and/or a control signal to control an aspect of the generation of a sound by the audio component 700. Such a control signal may directly convey the sound to the audio component 700 to be generated by an acoustic driver thereof (e.g., an analog or digital signal conveying an electrical representation of the sound). Alternatively or additionally, the control signal may convey an indication of a selection of the sound to generate (e.g., a selection of one of multiple sounds for which recordings or other representations thereof may be stored within the audio component 700).

As depicted, the lighting components 800 may each have any of a variety of shapes and incorporate one or more lighting elements, such as light-emitting diodes (LEDs) to generate light of one or more colors. The possible shapes of each of the lighting components 800 may include and are not limited to shapes resembling animals, plants, people, such as objects as may be found in countryside scenery, portions of houses, etc. By way of example, and as depicted in FIG. 2, ones of the lighting components 800 may have the shape of a rod, a panel, a snowman, a pumpkin, an alphanumeric character (e.g., the depicted numeral “7”), a plant or tree (e.g., the depicted pine tree), etc. The one or more lighting elements incorporated into each possible embodiment of one of the lighting components 800 may be of a single color, multiple colors, changing colors, white, etc.

Ones of the lighting components 800 having the shape of rods, numbers, alphanumeric characters or other elongate shapes may be formed from one or more transparent or translucent tubes and/or other containment structures to seal out food particles or liquids, and within which one or more lighting elements (e.g., LEDs) may be disposed. Ones of the lighting components 800 having the shape of a flat panel with one or more lighting elements disposed thereon, and such a flat panel shape may be coated with a sealant to seal out food particles or liquids. Such lighting components may incorporate a flexible or rigid sheet-like substrate on which lighting elements may be supported and/or which may incorporate electrical conductors, including and not limited to, a flexible or rigid portion of a plastic sheet, flat cardboard, a rigid or flexible printed circuitboard, etc.

One or more of the lighting components 800 may be shaped to resemble a person or other type of character (e.g., the depicted snowman), a plant (e.g., the depicted pine tree), a building (e.g., a house), an animal, etc.; and may have one or more lighting elements disposed on one or more surfaces thereof. Alternatively or additionally, one or more of the lighting components may be shaped to be incorporated into an edible construction (e.g., as a fence post, column, roof portion, chimney, etc.). Aside from being shaped to resemble an object, one or more of the lighting components 800 may be decorated with colors, patterns, etc., and/or may have printed or otherwise formed thereon images of objects. By way of example, and referring to FIG. 2, the one of the lighting components 800 shaped to resemble a tree may also have printed thereon colored images of branches, twigs, leaves, needles, etc. of a tree. By way of another example, and also referring to FIG. 2, the one of the lighting components 800 shaped as panel of lighting elements may have printed thereon or otherwise formed thereon, images of window panes of a window.

Each of the lighting components 800 incorporates a connector 895 by which each of the lighting components 800 may be coupled to the base 500 to receive electric power and/or a control signal to control an aspect of the generation of light by each of the lighting components 800. Such a control signal may be part of the direct provision of power to a selected one or ones of the lighting elements of one of the lighting components 800. By way of example, where LEDs are employed as lighting elements, the provision of electric power with a selected polarity across two or more conductors, and/or with alternating polarity (e.g., alternating current) may be employed to select one or more possible colors. Alternatively or additionally, the control signal may convey an indication of a selection of a color of light to generate (e.g., a selection of one of multiple possible colors and/or relative levels of light output of two or more colors, such as red, green and/or blue, that are mixed to generate any of multiple possible colors).

The connectors 795 and/or 895 are coupled to the base 500 by inserting the connectors 795 and/or 895 into ones of the apertures 505. Beneath the support surface 501 and adjacent at least a subset of the apertures 505 may be electrical conductors to engage electrically conductive contacts of the connectors 795 and/or 895 when the connectors 795 and/or 895 are inserted through ones of that subset of the apertures 505.

In some embodiments, insertion of one or more of the connectors 795 and/or 895 into ones of the apertures 505 may entail inserting the one or more of those connectors through the overlay sheet 600. As depicted, the overlay sheet 600 has a top surface 601 and an opposing bottom surface 602. The bottom surface 602 of the overlay sheet 600 faces and comes into contact with the support surface 501 of the base 500 when the overlay sheet 600 is overlain atop the base 500. As has been discussed, the top surface 601 of the overlay sheet 600 may visually present various indicia providing visual guidance of locations at which to position portions of an edible construction during assembly of that edible construction and/or of locations at which to position ones of the audio component 700 and/or the lighting components 800. Thus, such indicia may visually indicate locations on the top surface 601 through which ones or more of the connectors 795 and/or 895 are to be inserted through the overlay sheet 600 to direct the insertion of those one or more of the connectors 795 and/or 895 into particular ones of the apertures 505 of the base 500.

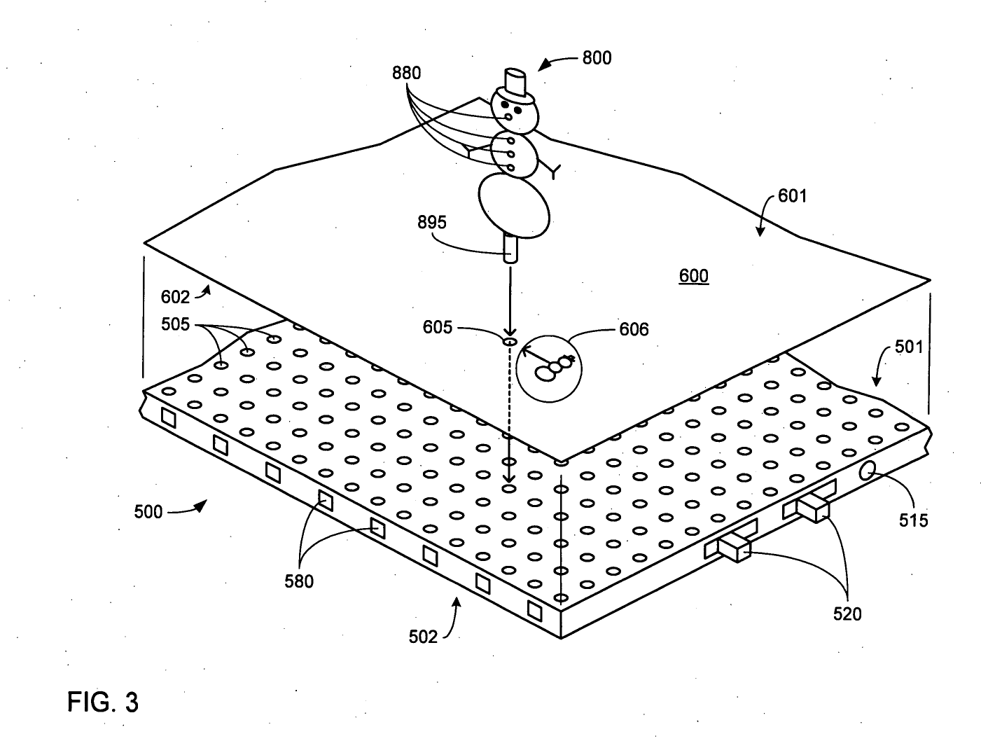

Referring to FIG. 3, the insertion of the connector 895 of one of the lighting components 800 (e.g., the one having the shape of a snowman) through the overlay sheet 600 and into one of the apertures 505 may form (e.g., tear) an aperture 605 through the overlay sheet 600. Again, there may be indicia 606 visually presented by the overlay sheet 600 (e.g., the depicted indicia 606 of a snowman) directing that the connector 895 be so inserted through the overlay sheet 600, thereby effectively directing that the aperture 605 be formed therethrough. One or more of the connectors 795 and/or 895 of one or more of the audio and/or lighting components 700 and/or 800, respectively, may have a shape selected to reduce the force that may need to be applied to cause penetration through the overlay sheet 600 to form the aperture 605. Alternatively or additionally, one or more apertures 605 may be preformed through the overlay sheet 600 to provide a visual guide as to where to position ones of the audio and/or lighting components 700 and/or 800 based on the positions of preformed one of the apertures 605.

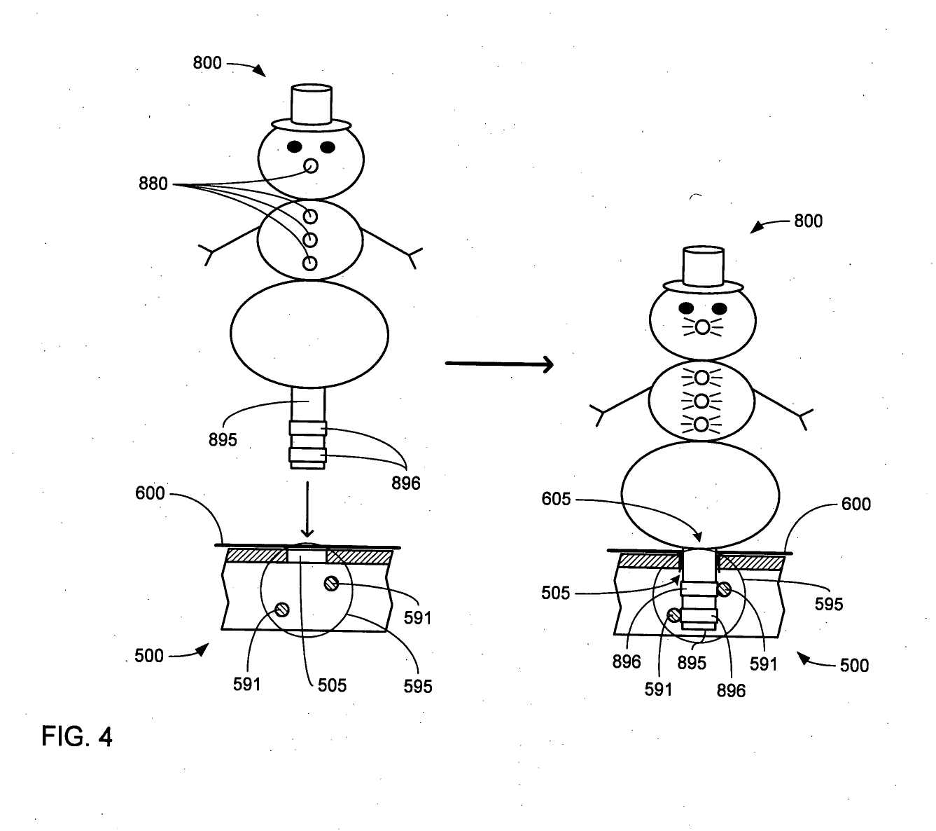

Referring to FIG. 4, the insertion of the connector 895 of one of the lighting components 800 into one of the apertures 505 results in electrically conductive contacts 896 of the connector 895 engaging conductors 591 of the base 500 to enable the provision of electric power by the base 500 to the one of the lighting components 800 now thereby coupled to the base 500. As depicted in FIG. 4 in cross-section, the conductors 591 may be bare metal wires aligned with at least a portion of the periphery of the aperture 505 to serve as electrically conductive contacts that engage in a “wiping” type of conductive contact with the contacts 896 of the connector 895.

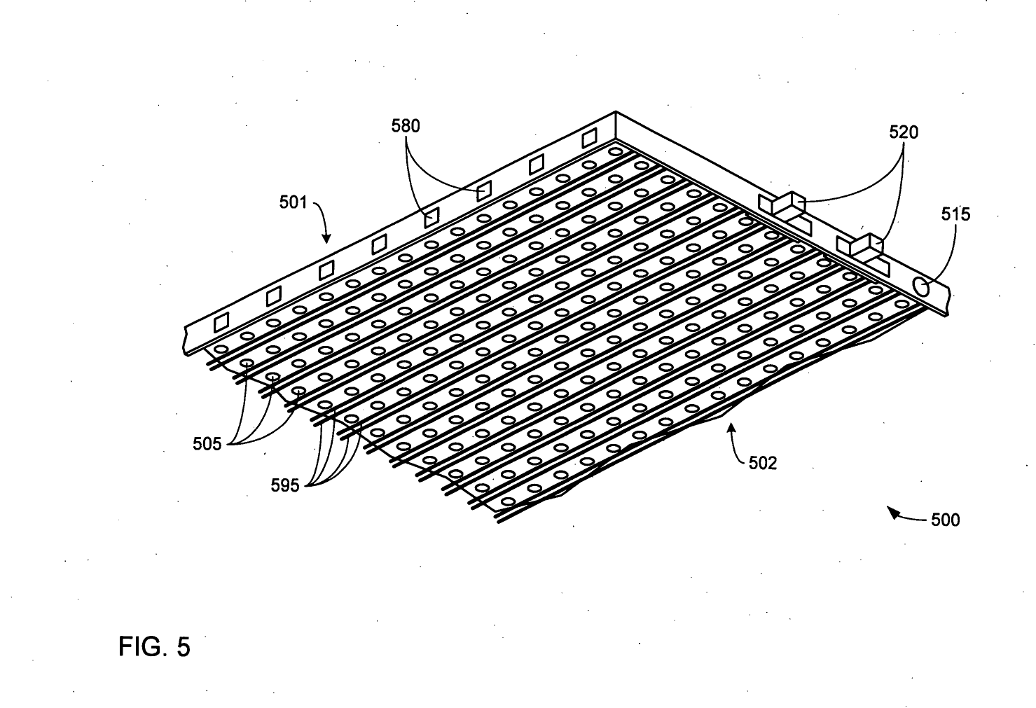

Referring to FIG. 5, parallel sets of the conductors 591 may extend within the base 500 in a manner that is aligned with at least a portion of the periphery of multiple ones of the aperture 505, thereby “bussing” electric power to the vicinities of numerous ones of the apertures 505. Such alignment of the conductors 591 with the peripheries of multiple ones of the apertures 505 effectively defines multiple female connectors (designated with reference numeral 595 in FIG. 4) that accept the male connectors 795 and/or 895. Thus, with the insertion of the connector 895 of the one of the lighting components 800 now thereby coupled to the base 500, electric power may now be able to be conveyed from the base 500 and to its lighting elements 880.

It should be noted that despite the depiction and discussion of pairs of the conductors 591 extending in alignment with at least a portion of the periphery of each of the apertures 505 to define connectors 595, other embodiments are possible in which other conductive elements are employed as electrically conductive contacts within the base 500, either in cooperation with or in place of the conductors 591. Alternatively or additionally, in embodiments employing the conductors 591 as wiping contacts aligned with peripheries of the apertures 505 as has been described, the arrangement of the conductors 591 may differ from what is depicted in FIG. 5. By way of example, the conductors 591 may be arranged to form a grid in which some of the conductors 591 extend perpendicularly to others of the conductors 591 such that they cross each other in a “row-column” arrangement.

Referring back to FIGS. 4 and 5, as depicted, the base 500 has a form resembling a tray with a relatively large and flat rectangular sheet-like portion joined at its periphery with relatively narrow edge portions extending in planes other than the plane of the large and flat sheet-like portion. As also depicted, this tray-like shape of the base 500 is oriented such that it “opens” downward such that this opening becomes the underside 502 defined largely by an open bottom, and the relatively large and flat sheet-like portion defines the support surface 501. As also depicted, the conductors 591 are spaced apart from each other and are spaced away from the large and flat sheet-like portion of the tray-like shape of the base 500 that defines the top surface 501.

This open bottom in combination with such spacing of the conductors 591 serves to render the base 500 relatively resistant to instances of short circuits developing between ones of the conductors 591 as a result of conductive food particles and/or food liquids entering into the base 500 through one or more of the apertures 505. The open bottom of the underside 502 allows food particles and/or liquids to easily “fall through” the base 500 with minimal resistance such that they are allowed to fall away from the conductors 591. The positioning of the conductors 591 as aligned with at least a portion of the peripheries of the apertures 505, instead of being positioned directly under the apertures 505, allows such falling food particles and/or liquids to fall through the apertures 505 and past the conductors 591, while making little or no contact with the conductors 591. The spacing away of the conductors 591 from the underside of the material of the base 500 defining the top surface 501 aids in preventing food liquids that may cling to the underside of that material as a result of their surface tension characteristics from also coming into contact with the conductors 591. And the spacing away of the conductors 591 from each other aids in preventing food particles and/or liquids that may come into contact with one of the conductors 591 from also coming into contact with another of the conductors 591 such that those two conductors 591 may be electrically coupled through such food particles and/or liquids.

The open bottom in combination with such spacing of the conductors 591 may also serve to enable the base 500 to be cleaned more easily between uses in supporting different edible constructions. Thus, the base 500 may be made hygienically reusable. In some embodiments, the base 500 may be made principally from a non-conductive, material selected to withstand cleaning with water and detergents, as well as some amount of heat, as is typically encountered with washing dishes in a kitchen. Correspondingly, the conductors 591 may be made from a conductive material selected to resist corrosion from such cleaning.

The need for such cleaning may be minimized through the use of various ones of the overlay sheet 600 to cover ones of the apertures 505 into no connectors 795 and/or 895 are inserted. Thus, the fact of the apertures 605 needing to be formed through the overlay sheet 600 as by poking the connectors 795 and/or 895 therethrough, and/or the fact of a limited quantity of the apertures 605 being preformed therethrough serves to limit the quantity of the apertures 505 into which foot particles and/or liquids may enter. In some embodiments, the apertures 505 may be formed just large enough in diameter to accommodate the insertion of typical cotton swabs therethrough to enable manual clearing of food particles and/or liquids that may become lodged in the apertures 505 and/or may become adhered to one of the conductors 591 thereunder. Indeed, the non-conductive material of the base 500 and/or of the conductive material of the conductors 591 may be selected to withstand exposure to alcohol and/or hydrogen peroxide that may be present on the cotton-covered tips of such cotton swabs to aid in effecting such clearing.

Referring back to FIGS. 3 and 5, as depicted, the base 500 may incorporate one or more controls 520 and/or one or more lighting elements 580. Not unlike the lighting elements 880 of the lighting components 800, the lighting elements 580 of the base 500 may be LEDs and may be operated to enhance an edible construction assembled atop the base 500 with visual lighting effects. As depicted, the lighting elements 580 may be disposed about at least a portion of the periphery of the base 500. However, other embodiments are possible in which the ones of the lighting elements 580 may be disposed about portions of the top surface 501.

The controls 520 may enable control over various aspects of the enhancement of an edible construction with lighting and/or sound effects. By way of example; the base 500 may incorporate one or more controls 520 to enable the selective provision of electric power to ones of the audio and/or lighting components 700 and/or 800, as well as any lighting elements 580 as may be disposed on the base 500 (e.g., an “on/off” switch). Alternatively or additionally, one or more controls 520 may be incorporated into the base 500 to enable selection of lighting and/or sound effects. The controls 520 may take any of a variety of forms, including and not limited to, rotary or slide switches, pushbuttons, touch-sensitive surfaces implemented with proximity sensors, key-operated switches, etc. As depicted, the controls 520 are made up of a pair of slide switches disposed along a portion of the periphery of the base 500.

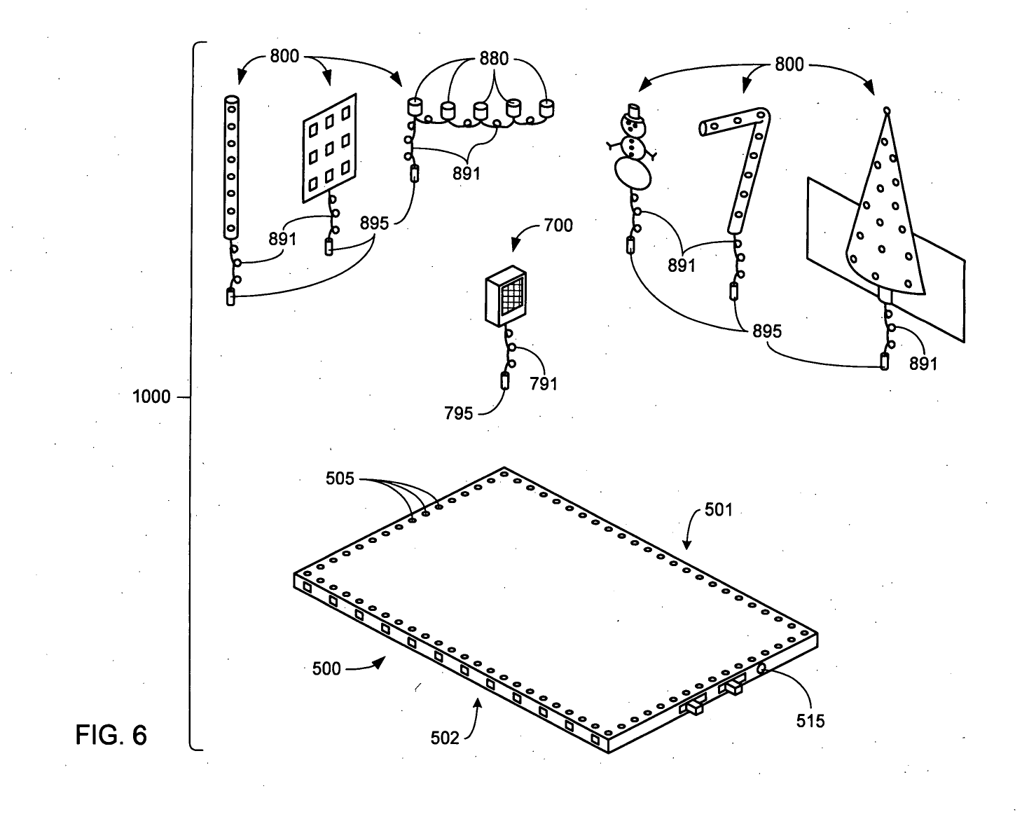

Referring to FIG. 6, in an alternate embodiment of the kit 1000, alternate embodiments of the audio component 700 and/or of the lighting components 800 may include wire lead conductors 791 and/or 891, respectively. Alternatively or additionally, an alternate embodiment of the base 500 may have a smaller quantity of the apertures 505 formed therethrough, and those apertures 505 may be disposed about the periphery of the top surface 501 of the base 500. Otherwise, as depicted in FIG. 6, the depicted alternate embodiments of the electrical components 500, 700 and 800 of the depicted alternate embodiment of the kit 1000 are substantially similar to their counterparts depicted in FIG. 2. Therefore, similar reference numerals are used between FIGS. 2 and 6 to label corresponding components.

Turning to the alternate embodiment of the audio component 700, the conductors 791 may be interposed between the connector 795 and the box-like structure in which at least an acoustic driver to generate sounds is disposed. This may allow the box-like structure to be positioned atop the base 500 at various locations without regard to the location of the one of the apertures 505 into which the connector 795 is inserted to obtain electric power from the base 500.

Turning to the alternate embodiments of the lighting components 800, the conductors 891 may be interposed between the connector 895 and whatever structure on which one or more of the lighting elements 880 may be disposed (e.g., the structure of one of the lighting components 800 that defines the shape of a snowman). This may allow such structures of each of the lighting components 800 to be positioned atop the base 500 at various locations without regard to the location of the one of the apertures 505 into which the connectors 895 are inserted to obtain electric power from the base 500.

Among the example embodiments of lighting components depicted in FIG. 6 is an embodiment made up principally of individual ones of the lighting elements 880 connected by segments of the conductors 891. Such an embodiment may enable greater freedom in providing visual enhancements to an edible structure by allowing the placement of individual ones of the lighting elements 880 about various portions of that edible construction as desired.

Turning to the alternate embodiment of the base 500, the disposing of a lesser quantity of the apertures 505 towards the periphery of the top surface 501 may enable the assembly of an edible construction directly atop the top surface 501 without an overlay sheet 600 interposed therebetween. However, such use of an overlay sheet 600 may still be deemed desirable, either for the benefit of indicia visually presented thereby to guide the positioning of portions of an edible construction and/or ones of the audio component 700 and/or the lighting components 800, or for the benefit of covering ones of the apertures 505 into which no connectors are inserted despite their placement about the periphery of the base 500.

It should be noted that despite the depiction of particular combination of embodiments of the audio component 700 and the lighting component 800 with a particular embodiment of the base 500 in each of FIGS. 2 and 6, other embodiments of the kit 1000 are possible that include any of a variety of possible mixtures of the embodiments of these electrical components 500, 700 and 800 depicted in FIGS. 2 and 6.

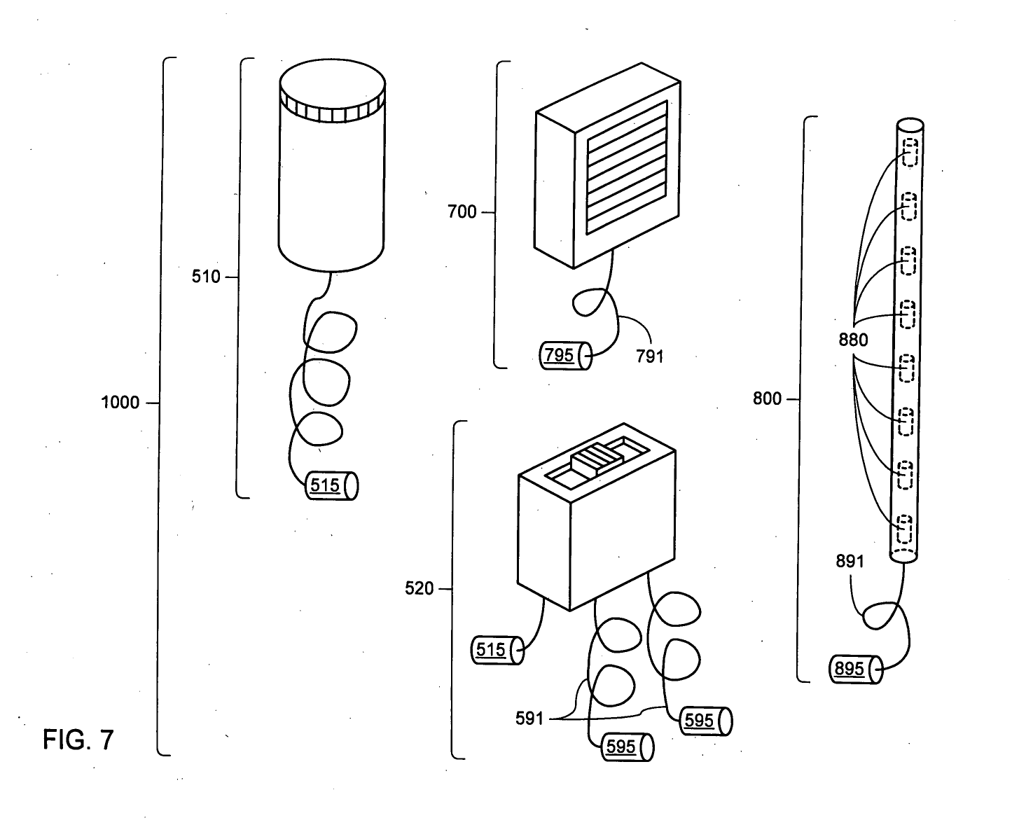

Further, in still another embodiment of the kit 1000 depicted in FIG. 7, the base 500 may be replaced by embodiments of the power supply 510 and/or the controls 520 that may be interconnected more directly with the alternate embodiments of the audio component 700 and/or one or more of the lighting components 800 of FIG. 6. Thus, an edible construction may be assembled atop some other surface, and connectors at the end of wire leads used to convey electric power among electric components in place of an array of connectors formed on a base.

The power supply 510, may supply low voltage electricity to the audio component 700 and/or one or more of the lighting components 800, and may do so through the controls 520. The connectors 515 by which the power supply 510 and the controls 520 may be coupled may be selected to form a sealed connection that resists entry of food particles and/or liquids therein to avoid the corroding of contacts and/or the formation of an electric circuit through food particles and/or liquids. The connectors 595, 795 and/or 895 may be similarly so selected.

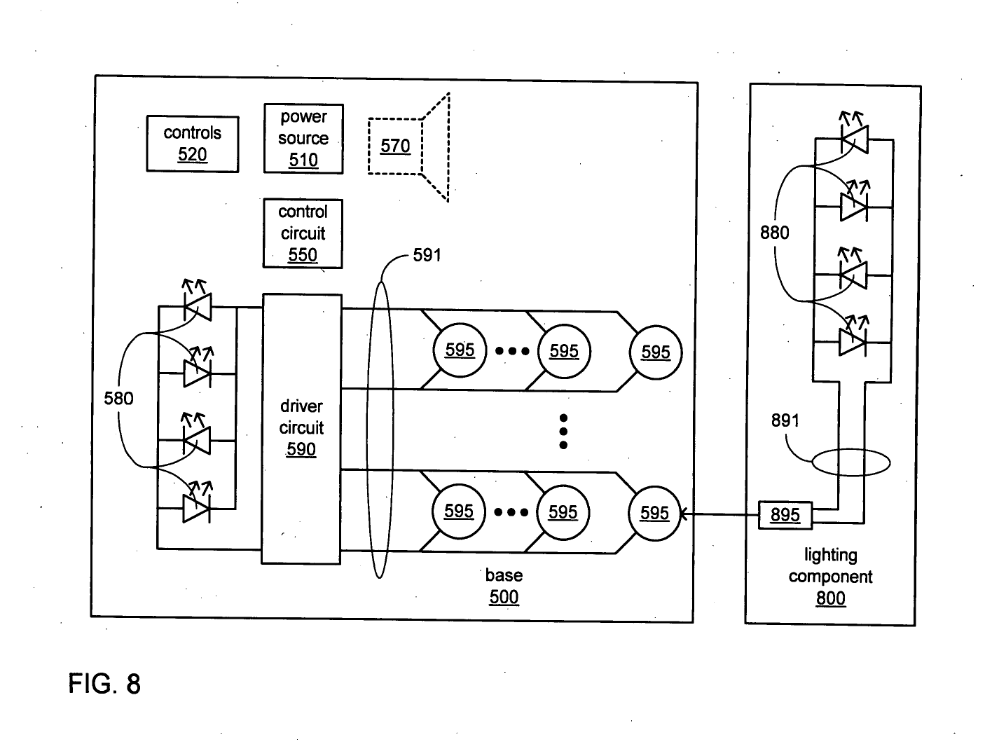

FIG. 8 depicts a schematic view of circuitry that may be employed in either of the embodiments of FIGS. 2 or 6 in implementing the base 500 and/or one or more of the lighting components 800. As has been discussed, the conductors 591 may cooperate with the apertures 505 to define a set of female connectors 595 of the base to which the male connector 895 of one of the lighting components 800 may be conductively coupled.

Turning to the schematic depiction of circuitry of the base 500, the base 500 may incorporate a driver circuit 590 to drive electric currents onto various ones of the conductors 591. The driver circuit 590 may incorporate any of a variety of electrical components to drive electric current from the power source 510 onto ones of the conductors 591, including and not limited to electromechanical relays, metal oxide switching field effect transistors (MOSFETs), silicon controlled rectifiers (SCRs), etc. In embodiments of the base 500 that incorporate lighting elements 580, the driver circuit 590 may also electrically drive the lighting elements 580. In various embodiments of the base 500, the driver circuit 500 may independently drive multiple ones of the conductors 591 with different currents in different polarities and/or with different polarities. Alternatively, the driver circuit 500 may drive parallel sets of the conductors 591 in unison with a common electric current.

As depicted in FIG. 8, the base 500 may also incorporate a control circuit 550 to operate the driver circuit 590 to drive the conductors 591 and/or the lighting elements 580 with electric currents drawn from the power source 510. In embodiments in which the base 500 incorporates one or more of the controls 520, the control circuit 550 may monitor the controls 520 for indications of operation of the controls 520 to convey commands affecting operation of the electrical components 500, 700 and/or 800. By way of example, the control circuit 550 may detect operation of the controls 520 to convey commands to turn the provision of sound and/or lighting effects on or off. The control circuit 550 may respond by operating the driver circuit 590 to either provide or cease to provide electric currents to the conductors 591 and/or the lighting elements 580, accordingly. Alternatively or additionally, the control circuit 550 may detect operation of the controls 520 to select a particular pattern of flashing of the light elements 580 of the base 500 and/or of the lighting elements 880 of one or more of the lighting components 880. The control circuit 550 may respond by operating the driver circuit 590 to drive the lighting elements 580 and/or the conductors 591 with various electric currents-to effect the particular pattern.

As also depicted, the base 500 may also incorporate an acoustic driver 570 to enable the generation of sounds by the base 500, directly, without the use of the audio component 700. In embodiments in which the base 500 incorporates one or more of the controls 520, the control circuit 550 may monitor the controls 520 for indications of operation of the controls 520 to select sounds to be generated. In response, the control circuit 550 may drive the acoustic driver 570 to generate the selected sounds. Alternatively or additionally, the control circuit 550 may operate the driver circuit 590 to drive a signal onto one or more of the conductors 591 to convey an indication to the audio component 700 to generate the selected sounds. It may be that a subset of the conductors 591 convey audio signals that are conveyed to the audio component 700 by one of that subset of the conductors 591 and a corresponding contact of the connector 795.

Turning to the schematic depiction of circuitry of one of the lighting components 800, such a one of the lighting components 800 may incorporate the conductors 891 conveying electric currents from the connector 895 to ones of the lighting elements 880. As depicted, the lighting elements 880 may be LEDs, and some of these LEDs may be coupled to the conductors 891 with a polarity in opposition to the polarity of others of these LEDs. This may be done to allow different ones of these LEDs to be turned on or off at different times by the control circuit 550 of the base 500 operating the driver circuit 590 to drive electric currents of different polarities onto ones of the conductors 591 that are electrically coupled to the conductors 891 through the connectors 595 and 895. More specifically, a continuous current driven with one polarity may cause some of these LEDs to be illuminated, while a continuous current driven with the opposite polarity may cause the others of these LEDs to be illuminated. Further, an alternating current may cause all of these LEDs to be illuminated.

It should be noted that the schematic depiction of circuitry of both the base 500 and of one of the lighting components 800 is somewhat simplified for sake of clarity and ease of understanding. More precisely, various electrical components that are often included in such circuitry are omitted from being depicted, such as current limiting resistors placed in series between the LEDs of the lighting component 500 and the connector 895, etc.

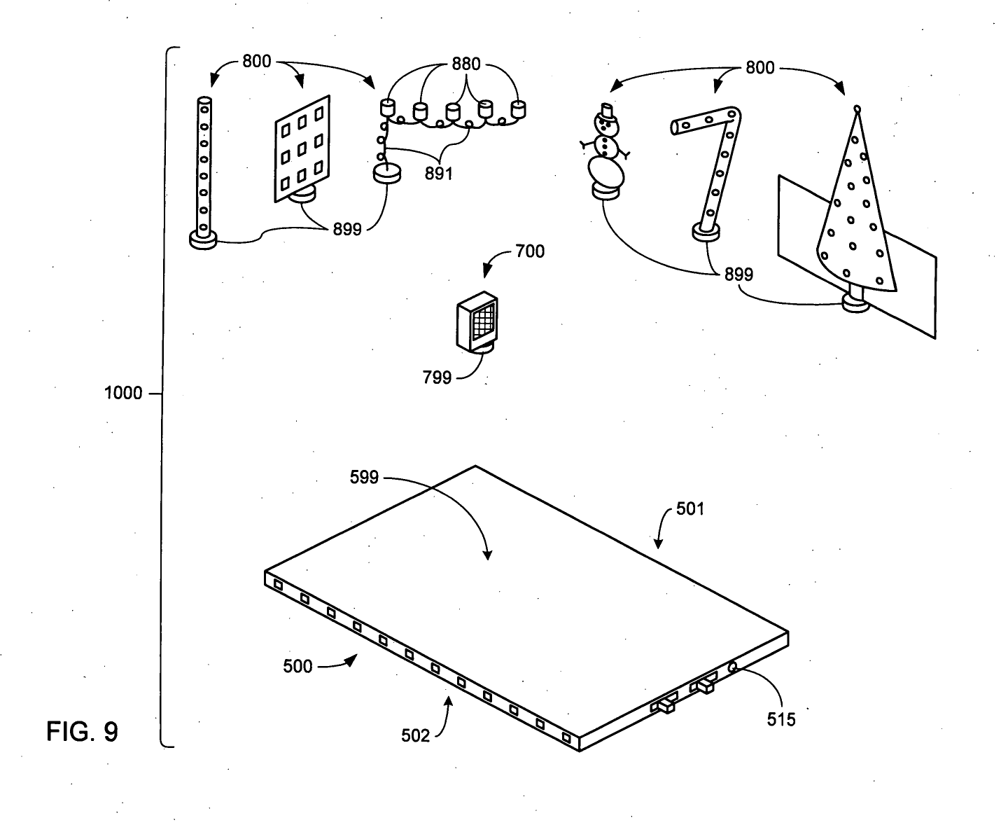

Referring to FIG. 9, in another alternate embodiment of the kit 1000, alternate embodiment's of the audio component 700 and/or of the lighting components 800 may include induction coils 799 and/or 899, respectively. Alternatively or additionally, an alternate embodiment of the base 500 may incorporate one or more induction coils 599 in lieu of connectors 595 to provide electric power to ones of the audio component 700 and/or the lighting components 800. Instead, the induction coil 599 of the base 500 generates an electromagnetic field that is received by the induction coils 799 and/or 899 of the audio component 700 and/or the lighting components 800, respectively, to convey electric power thereto. Otherwise, the depicted alternate embodiments of the electrical components 500, 700 and 800 of the depicted alternate embodiment of the kit 1000 of FIG. 9 are substantially similar to their counterparts depicted in FIGS. 2 and 6. Therefore, similar reference numerals are used between FIGS. 2, 6 and 9 to label corresponding components.

Turning to the alternate embodiment of the base 500 of FIG. 9, the replacement of the connector 595 defined by aligned combinations of the apertures 505 and the conductors 591 with the induction coil(s) 599 results in the top surface 501 being a continuous surface unbroken by the apertures 505. Thus, there are no apertures 505 into which food particles and/or liquids may fall. This may enable any use of the overlay sheet 600 to be dispensed with, although such use of an overlay sheet 600 may still be deemed desirable for the benefit of indicia visually presented thereby to guide the positioning of portions of an edible construction and/or ones of the audio component 700 and/or the lighting components 800.

Turning to the alternate embodiment of the audio component 700 of FIG. 9, the induction coil 799 replaces the connector 795. This may allow audio component 700 to be positioned at any location on the top surface 501 of the base 500 at which the induction coil 599 of the base 500 is able to provide an electromagnetic field.

Turning to the alternate embodiment of the lighting components 800 of FIG. 9, the induction coil 899 replaces the connector 895. This may allow the lighting components 800 to be positioned at any location on the top surface 501 of the base 500 at which the induction coil 599 of the base 500 is able to provide an electromagnetic field.

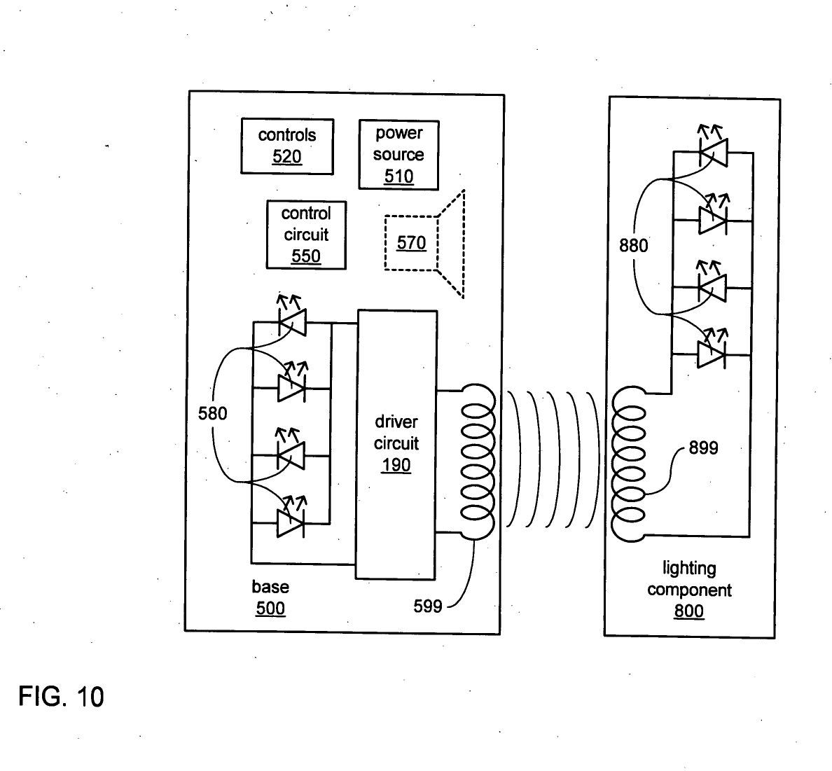

FIG. 10 depicts a schematic view of circuitry that may be employed in the embodiment of FIG. 9 in implementing the base 500 and/or one or more of the lighting components 800. As has been discussed, the induction coils 199 and 899 may cooperate to generate and receive an electromagnetic field to convey electric power from the base 500 to one or more of the lighting components 800. Otherwise, the depicted circuitry that may be employed by one or both of the base 500 and one or more of the lighting components 800 is substantially similar to what is depicted in FIG. 8. Therefore, similar reference numerals are used between FIGS. 8 and 10 to label corresponding components.

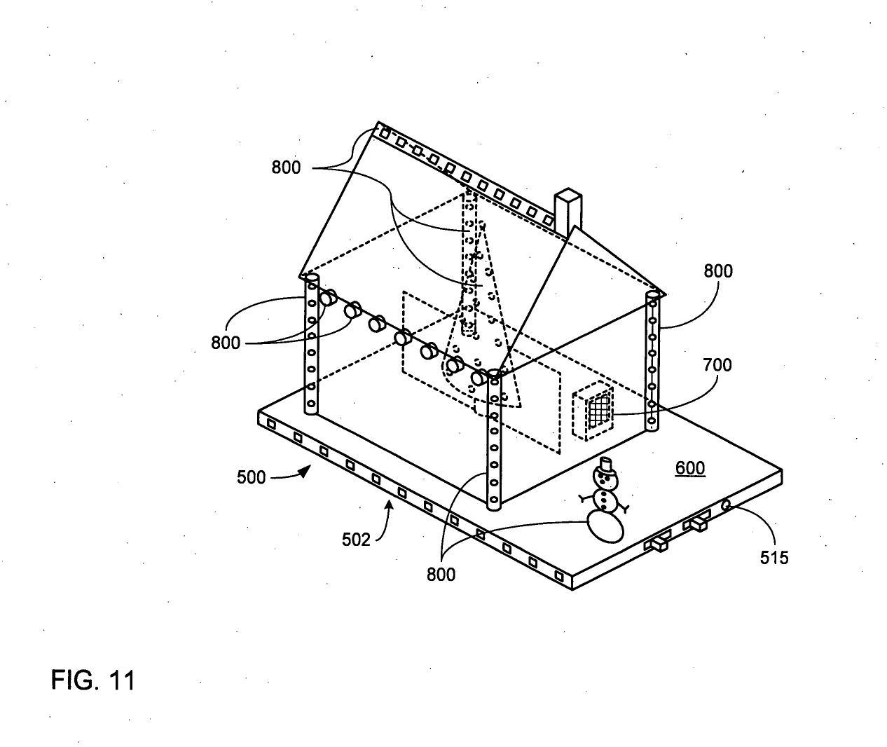

FIG. 11 depicts an example of the use of embodiments of the base 500, the overlay sheet 600, the audio component 700 and multiple ones of the lighting components 800. Some of these embodiments of these components may be selected from one or more of the embodiments of the kit 1000 depicted in any of FIGS. 2, 6 or 9. As depicted in FIG. 11, an edible construction in the form of a gingerbread house has been assembled atop the overlay sheet 600 as overlain atop the base 500.

The audio component 700 and one of the lighting components shaped to resemble a pine tree has been positioned within the edible construction, while one of the lighting components 800 shaped to resemble a snowman has been position outside the edible construction. Windows and/or doors (not shown) may be formed through walls of the edible construction to enable the lighting component 800 positioned within the edible construction to be viewed and to enable sounds generated by the audio component 700 positioned within the edible construction to be heard.

Integrated into corners of walls of the edible construction are ones of the lighting components shaped as rods. Disposed along a portion of a roof line of the edible construction is one of the lighting components 800 made up of individual ones of the lighting elements 880 connected by segments of the conductors 891. Additionally integrated into the peak of the roof of the edible construction is another lighting component 800 made up of an elongate folded panel to lie along and/or define the peak of the roof, multiple lighting elements disposed along the length of the folded panel, and additional material defining a top portion of a chimney.

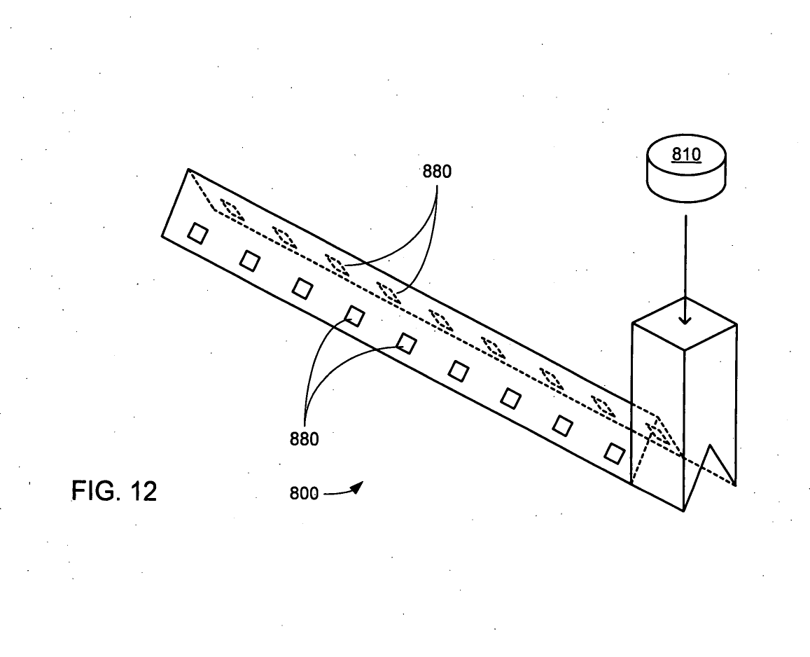

FIG. 12 illustrates an embodiment of the lighting component 800 depicted in FIG. 11 as integrated into the peak of the roof of an edible structure in greater detail. As depicted, multiple lighting elements 880 are disposed lengthwise along a folded elongate flat portion of the lighting component 800 that defines the peak and which carries another portion that additionally defines a chimney. As also depicted, the chimney may be employed to house a removable power source 810 (e.g., a generally disc-shaped battery). In this way, this embodiment of a lighting component 800 may be independently powered, thus not requiring an electrical connection to a base 500 or any other electrical component.

As previously discussed, ones of the lighting components having a portion in the shape of a panel or other flat shape may have printed thereon (or otherwise formed thereon) various decorative markings and/or formations. Thus, the folded elongate flat portion of the light component 800 depicted in FIG. 12 may similarly have printed and/or formed thereon various decorative markings and/or formations. By way of example, decorative markings depicting strands of wiring typical of decorative lighting applied about the roof of a house may be printed on the folded elongate flat portion to convey an appearance of the lighting elements 880 being components of such decorative lighting.

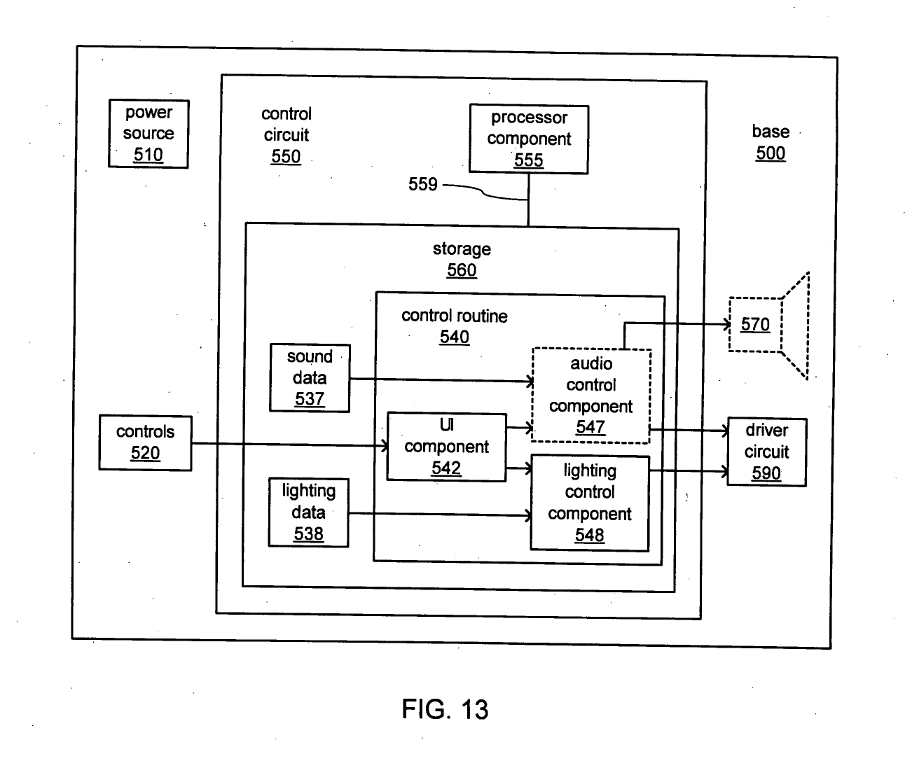

FIG. 13 illustrates an embodiment of a processing architecture suitable for implementing the control circuit 550 of either of the embodiments of circuitry of the base depicted in FIGS. 8 or 10. As depicted, the control circuit 550 incorporates at least a processor component 555, a storage 560 and a coupling 559.

The coupling 559 includes one or more buses, point-to-point interconnects, transceivers, buffers, crosspoint switches, and/or other conductors and/or logic that communicatively couples at least the processor component 550 to the storage 560. The coupling 559 may further couple the processor component 550 to one or more other components. With the processor component 550 being so coupled by the coupling 559, the processor component 550 is able to perform the various ones of the tasks described above as performed by the control circuit 550.

The coupling 559 may be implemented with any of a variety of technologies or combinations of technologies by which signals are optically and/or electrically conveyed. The processor component 550 may include any of a wide variety of commercially available processors, employing any of a wide variety of technologies and implemented with one or more cores physically combined in any of a number of ways.

The storage 560 may be made up of one or more distinct storage devices based on any of a wide variety of technologies or combinations of technologies. More specifically, the storage 560 may include one or more of volatile storage (e.g., solid state storage based on one or more forms of RAM technology), non-volatile storage (e.g., solid state, ferromagnetic or other storage not requiring a constant provision of electric power to preserve their contents), or removable media storage (e.g., removable disc or solid state memory card storage by which information may be conveyed between computing devices).

The storage 560 may include an article of manufacture in the form of a non-transitory machine-readable storage media on which a routine including a sequence of instructions executable by the processor component 550 may be stored, depending on the technologies on which each is based. Thus, a routine including a sequence of instructions to be executed by the processor component 550 may initially be stored on a non-transitory machine-readable storage medium of the storage 560. That routine may then be copied from that medium to a portion of to volatile portion of the storage 560 to enable more rapid access by the processor component 550 as that routine is executed by the processor component 550.

As depicted in FIG. 13, stored within the storage 560 is a control routine 540 made up of a sequence of instructions that when executed by the processor component 550 cause the processor component 550 to operate the driver circuit 590 to provide power and/or control signals to other electrical components. In so doing, the processor 550 is caused to provide electric power and/or control signals to the connectors 595 by which electric power and/or control signals are conveyed to the audio component 700 and/or one or more of the lighting components 800.

The control routine 540 may include a user interface (UI) component 542 for execution by the processor component 550 to monitor the controls 520 to receive indications of operation of the controls 520 to convey commands. The commands so received from operation of the controls 520 may include a command to turn on or off at least part of the provision of sound and/or lighting to enhance an edible construction. Alternatively or additionally, the commands so received may include a command to select a particular pattern of flashing of the lighting elements 880 of one or more of the lighting components 800. Alternatively or additionally, the commands so received may include a command to select a particular sound to be generated by an acoustic driver of the audio component 700 and/or by the acoustic driver 570 (if present) of the base 500.

The control routine 540 may include an audio control component 547 for execution by the processor component 550 to operate the acoustic driver 570 (if present) of the base 500 to generate sounds and/or to operate the driver circuit 590 to signal the audio component 700 to generate sounds. In embodiments of the base 500 that incorporate the acoustic driver 570, the storage 560 may additionally store sound data 537 made up of digitized recordings and/or other representations of various sounds, including and not limited to, animal sounds, nature sounds, sounds of a city street, voice sounds, Halloween sounds, holiday music, or other sounds that may be appropriate to and/or that may enhance an experience intended to be provided by viewing a particular edible construction. The audio control component 547 may receive indications of selections of sounds from the UI component 542, and in response, may retrieve recordings or other representations of the selected sounds from the sounds data 537, and then operate the acoustic driver 570 to generate the selected sounds.

Alternatively, at least in embodiments that do not incorporate the acoustic driver 570, the audio control component 547 may receive indications of selections of sounds from the UI component 542, and in response, operate the driver circuit 590 to signal the audio component 700 to generate the selected sounds. The audio component 700 may internal store digitized recordings and/or other representations of the selected sounds to be generated.

The control routine 540 may include a lighting control component 548 for execution by the processor component 550 to operate the driver circuit 590 to provide electric and/or control signals to one or more of the lighting components 800 to generate light. The lighting control component 548 may receive indications of selections of'flashing patterns and/or lighting colors from the UI component 542. In response, the lighting control component 548 may operate the driver circuit 590 to provide electric power to one or more of the lighting components 800 with particular polarities. As has been discussed, one or more of the lighting components 800 may employ LEDs as its lighting elements 880, and different ones of those LEDs may be operable (whether through conductors and connectors or through induction coils) to be illuminated at different times through provision of electric power of different polarities and/or with alternating current.

Alternatively or additionally, in response to receiving such indications from the UI component 542, the lighting control component 548 may operate the driver circuit 590 to transmit a control signal (whether through conductors employed to convey control signals or through induction coils) to one or more of the lighting components 800 that conveys an indication of a selection of a flashing pattern and/or a color of illumination. Regardless of the manner in which the lighting components 800 are driven to do it, the lighting elements 880 of the lighting components 800 may be drive to provide lighting achieving various effects, including and not limited to, simulating holiday lights, simulating lighting that decorates the exterior of a house, etc.

Although the invention has been described in a preferred form with particularity, it is understood that the present disclosure of the preferred form has been made only by way of example, and that numerous changes in the details of construction and the combination and arrangement of parts may be resorted to without departing from the spirit and scope of the invention.

1. A kit comprising:
at least one food ingredient able to be prepared to form at least one portion of an edible construction; and
at least one electrical component able to be electrically coupled and assembled with the edible construction to visually enhance the edible construction.

2. The kit of claim 1, the at least one electrical component comprising at least one of a lighting component comprising,at least one lighting element, an audio component comprising at least one acoustic driver, a power source to provide electric power from at least one battery, a power source to provide electric power from AC mains, or a base to distribute electric power to the at least one electrical component.

3. The kit of claim 1, the at least one electrical component comprising a lighting component comprising a portion shaped to resemble at least one of a person, a plant, a tree, a house, a snowman, a pumpkin or an alphanumeric character.

4. The kit of claim 1, the at least one electrical component comprising a lighting component comprising a portion on which is printed decorative markings to resemble at least one of tree leaves, a tree branch, snow, ice, a strand of wiring of decorative lighting or a candle.

5. The kit of claim 1, the at least one electrical component comprising a lighting component comprising one or more light-emitting diodes (LEDs) disposed with a portion of the lighting component sealed against infiltration by food particles or liquids to enable embedding in the at least one portion of the edible construction.

6. The kit of claim 1, the at least one electrical component comprising an audio component comprising an acoustic driver to generate a sound, the sound comprising at least one of a voice sound, music, an animal sound or a sound of an outdoor environment.

7. The kit of claim 1, the at least one electrical component comprising a base comprising:
a surface to physically support the edible construction and other electrical components of the at least one electrical component; and
a plurality of connectors to receive mating connectors of the other electrical components to provide electric power to the other electrical components.

8. The kit of claim 7, comprising an overlay sheet to overlie the surface of the base, and through which at least one aperture is formed that aligns with one connector of the plurality of connectors to guide positioning of the at least one portion of the edible construction or another electrical component of the at least one electrical component.

9. The kit of claim 1, the at least one electrical component comprising a base comprising:
a surface to physically support the edible construction and another electrical component of the at least one electrical component; and
an induction coil to generate an electromagnetic field to provide electric power to the other electrical component.

10. The kit of claim 9, comprising an overlay sheet to overlie the surface of the base, and on a surface of which is visually presented indicia to guide positioning of the at least one portion of the edible construction or the other electrical component.

11. A kit comprising:
a base comprising a substantially flat support surface through which a plurality of apertures defining female electrical connectors are formed; and
an overlay sheet to overlie the support surface and visually presenting indicia indicating at least one location at which to penetrate the overlay sheet with a male connector,of an electrical component, the at least one location positioned on the overlay sheet to overlie at least one aperture of the plurality of apertures when the overlay sheet is overlain atop the support surface to direct insertion of the male connector through the overlay sheet and into the at least one female connector.

12. The kit of claim 11, comprising the electrical component, the electrical component comprising at least one of a lighting component comprising at least one lighting element, or an audio component comprising at least one acoustic driver.

13. The kit of claim 12, the lighting component comprising a portion shaped to resemble at least one of a person, a plant, a tree, a house, a snowman, a pumpkin or an alphanumeric character.

14. The kit of claim 12, the lighting component comprising one or more light-emitting diodes (LEDs) disposed with a portion of the lighting component sealed against infiltration by food particles or liquids to enable embedding in the at least one portion of an edible construction physically supported by the support surface.

15. The kit of claim 12, the audio component comprising an acoustic driver to generate a sound, the sound comprising at least one of a voice sound, music, an animal sound or a sound of an outdoor environment.

16. The kit of claim 11, the indicia comprising an aperture preformed through the overlay sheet at the at least one location.

17. The kit of claim 11, the indicia indicating at least one other location at which a portion of an edible construction is to be positioned during assembly of the edible construction atop the overlay sheet when the overlay sheet is overlain atop the support surface.

18. An apparatus comprising:
a substantially flat sheet-like portion having a first face and an opposing second face, the first face defining a support surface to support an edible construction and the second face defining an underside;
an aperture formed through the sheet-like portion between the support surface and the underside to receive a male connector of an electrical component; and
a first electrical conductor extending along the underside and aligned with a portion of a periphery of the aperture to cooperate with the aperture to define a female connector in which the first electrical conductor engages a first electrical contact of the male connector in a wiping contact when the male connector is inserted through the aperture, wherein no portion of the first electrical conductor extends underneath the aperture to enable food particles or liquid to fall through the aperture and past the first electrical conductor.

19. The apparatus of claim 18, comprising a second electrical conductor extending along the along the underside and aligned with another portion of the periphery of the aperture to engage a second electrical contact of the male connector in a wiping contact when the male connector is inserted through the aperture, wherein no portion of the second electrical conductor extends underneath the aperture to enable food particles or liquid to fall through the aperture and past the second electrical conductor.

20. The apparatus of claim 19, the first and second conductors spaced apart from each other to prevent a food particle from bridging the first and second conductors to form an electric circuit therebetween.

21. The apparatus of claim 18, the first electrical conductor spaced away from the underside to allow a food liquid passing through the aperture from the support surface to remain in contact with the underside as a result of surface tension without coming into contact with the first electrical conductor.

22. The apparatus of claim 18, the first electrical conductor extending in alignment with portions of a plurality of apertures formed through the sheet-like portion between the support surface and the underside.

23. The apparatus of claim 18, comprising a power source to provide an electric current between the first electrical conductor and the first contact of the male connector.

24. The apparatus of claim 23, comprising a control to change a polarity of the electric current.

25. The apparatus of claim 18, comprising the electrical component, the electrical component comprising at least one of a lighting component comprising at least one lighting element, or an audio component comprising at least one acoustic driver.

26. The apparatus of claim 25, the lighting component comprising a first light-emitting diode (LED) and a second LED, the first and second LEDs coupled to the male connector with opposing polarities, the apparatus comprising a driver circuit to drive a current between the first electrical conductor and the first contact with a first polarity to illuminate the first LED and a second polarity to illuminate the second LED.

27. An apparatus comprising:
a substantially flat support surface to physically support an edible construction;
an electrical component having a decorative shape comprising at least one lighting element to generate light; and
an induction coil to generate an electromagnetic field at the support surface to convey electric power to the electrical component to illuminate the lighting element.

28. The apparatus of claim 27, comprising a driver circuit coupled to the induction coil to drive the induction coil to signal the electrical, component to flash the lighting element.

29. The apparatus of claim 27, the electrical component comprising another induction coil to receive the electromagnetic field to illuminate the lighting element.

30. The apparatus of claim 27, comprising an overlay sheet to overlie the support surface and visually presenting indicia indicating at least one location at which to position at least one of the electrical component or at least a portion of the edible construction atop the overlay sheet when the overlay sheet is overlain atop the support surface.

31. The apparatus of claim 27, comprising another electrical component comprising an acoustic driver, the induction coil to generate the electromagnetic field at the support surface to convey electric power to the other electrical component to enable production of sound by the acoustic driver.
